(19) United States
(12) Patent Application Publication
(10) Pub. No.: US 2013/0047876 A1
(43) Pub. Date: Feb. 28, 2013

(54) DOCTOR BLADE APPARATUS AND PRINTING METHOD USING THE SAME

(71) Applicants: Jin Hyuk JUNG, Gyeonggi-do (KR); Tae Jun Choi, Gyeonggi-do (KR); Yang Soo Choi, Gyeonggi-do (KR)

(72) Inventors: Jin Hyuk JUNG, Gyeonggi-do (KR); Tae Jun Choi, Gyeonggi-do (KR); Yang Soo Choi, Gyeonggi-do (KR)

(73) Assignee: SAMSUNG ELECTRO-MECHANICS CO., LTD.

(21) Appl. No.: 13/568,821

(22) Filed: Aug. 7, 2012

(30) Foreign Application Priority Data
Aug. 30, 2011 (KR) 10-2011-0087368

(51) Int. Cl. B41F 31/20

(52) U.S. Cl. 101/350.6; 101/483

(57) ABSTRACT

Disclosed herein is a doctor blade apparatus, including a printing cylinder; a pre-wipe removing a portion of ink applied to a surface of the printing cylinder, while being spaced apart from the surface of the printing cylinder; and a blade removing the ink applied to the surface of the printing cylinder, while being in contact with the surface of the printing cylinder, whereby a life span of the blade can be remarkably improved and work suspension due to replacing the blade can be minimized. Furthermore, abrasion of the printing cylinder generating friction with the blade can be minimized, such that the entire lifespan of printing equipment can be improved.

### CROSS REFERENCE(S) TO RELATED APPLICATIONS

This application claims the benefit under 35 U.S.C. Section 119 of Korean Patent Application Serial No. 10-2011-0087368, entitled “Doctor Blade Apparatus and Printing Method Using the Same” filed on Aug. 30, 2011, which is hereby incorporated by reference in its entirety into this application.

### BACKGROUND OF THE INVENTION

1. Technical Field

The present invention relates to a doctor blade apparatus and a printing method using the same, and more particularly, to a doctor blade apparatus removing ink from an unnecessary portion in performing gravure printing and a printing method using the same.

2. Description of the Related Art

Gravure printing refers to a scheme of filling ink in a groove formed on a surface of a printing cylinder and removing ink in portions other than the groove to thereby transfer only the ink filled in the groove to an object to be printed. In particular, a tool for removing ink in portions other than a groove is referred to as a doctor blade, which generally scrapes the surface of a printing roll using a blade made of a metal material to thereby remove ink in portions other than a groove.

The doctor blade scrapes the ink, while being in contact with a printing cylinder, thereby generating friction with the printing cylinder. Due to the friction, abrasion of the blade is caused during the process and consequently, the abraded blade impacts processing performance. Therefore, the abraded blade needs to be replaced by a new blade. As a result, work is suspended for replacing the blade, which may cause a rapid reduction in productivity of printing work.

In order to solve the problems mentioned above, a blade is being manufactured using a high hardness material by special heat-treatment or an abrasion of the blade is being prevented by surface treatment such as metal coating, ceramic coating, or the like. However, this may instead cause abrasion to a printing cylinder due to improved strength of the blade.

### SUMMARY OF THE INVENTION

An object of the present invention is to provide a doctor blade apparatus capable of minimizing work suspension due to replacing a blade for removing ink by scraping a surface of a printing cylinder at the time of gravure printing and improving a lifespan of the blade and the printing cylinder, and a printing method using the same.

According to an exemplary embodiment of the present invention, there is provided a doctor blade apparatus, including: a printing cylinder; a pre-wipe removing a portion of ink applied to a surface of the printing cylinder, while being spaced apart from the surface of the printing cylinder; and a blade removing the ink applied to the surface of the printing cylinder, while being in contact with the surface of the printing cylinder.

The doctor blade apparatus may further include a spacing device allowing the pre-wipe to be spaced apart from the surface of the printing cylinder by a predetermined interval.

The spacing device may include: a bearing fixed to a side of the printing cylinder; a clamp enclosing an outer peripheral surface of the bearing; and a link having one end connected to the clamp and having the pre-wipe installed thereon.

The doctor blade apparatus may further include an elastic member applying elasticity to the link in a longitudinal direction.

The doctor blade apparatus may further include a pre-wipe holder controlling the position of the pre-wipe.

According to another exemplary embodiment of the present invention, there is provided a printing method using a doctor blade apparatus, the method including: removing a portion of ink applied to the surface of a printing cylinder using a pre-wipe installed to be spaced apart from the surface of the printing cylinder; removing the ink applied to the surface of the printing cylinder using a blade installed to be in contact with the surface of the printing cylinder; and transferring ink filled in the groove of the printing cylinder to an object to be printed.

The method may further include, before the removal of the ink using the pre-wipe, applying ink to a surface of the printing cylinder by rotating the printing cylinder in a state in which a portion of the printing cylinder is immersed in an ink tank.

### BRIEF DESCRIPTION OF THE DRAWINGS

FIG. 1 is a plan view of a doctor blade apparatus according to the present invention;

FIG. 2 is a side view of the doctor blade apparatus of FIG. 1; and

FIG. 3 is a partially enlarged view of part A of FIG. 2.

### DESCRIPTION OF THE PREFERRED EMBODIMENTS

Hereinafter, exemplary embodiments of the present invention will be described with reference to the accompanying drawings. However, the exemplary embodiments are described by way of examples only and the present invention is not limited thereto.

In describing the present invention, when a detailed description of well-known technology relating to the present invention may unnecessarily make unclear the spirit of the present invention, a detailed description thereof will be omitted. Further, the following terminologies are defined in consideration of the functions in the present invention and may be construed in different ways by the intention of users and operators. Therefore, the definitions thereof should be construed based on the contents throughout the specification.

As a result, the spirit of the present invention is determined by the claims and the following exemplary embodiments may be provided to efficiently describe the spirit of the present invention to those skilled in the art.

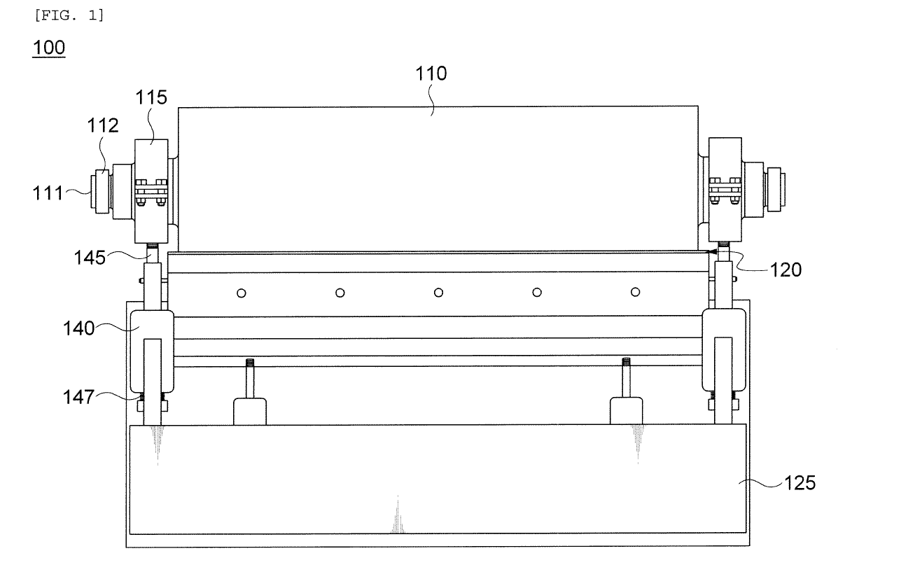

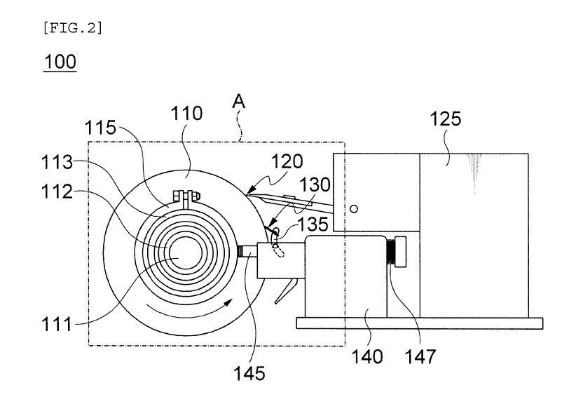

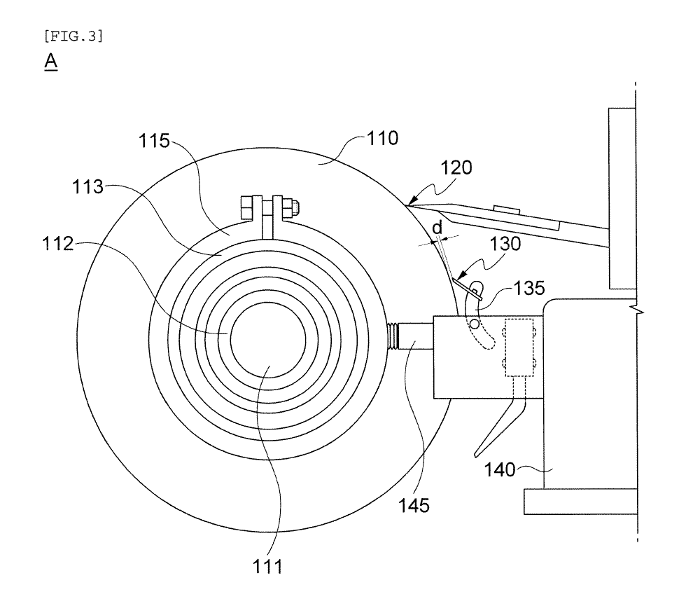

FIG. 1 is a plan view of a doctor blade apparatus according to the present invention, FIG. 2 is a side view of the doctor blade apparatus of FIG. 1, and FIG. 3 is a partially enlarged view of part A of FIG. 2. Referring to FIGS. 1 to 3, a doctor blade apparatus 100 according to the present invention is configured to include a printing cylinder 110, a blade 120, and a pre-wipe 130.

The printing cylinder 110 has a groove formed on the surface thereof and a shape intended to be printed and transfers ink filled in the groove to an object to be printed, while being rotated, to thereby perform printing.

The blade 120 is supported by a blade support 125 and in contact with the printing cylinder 110. When the printing cylinder 110 is rotated, the blade 120 scrapes and removes the ink smeared on the surface of the printing cylinder 110 In this case, the ink filled in the groove of the printing cylinder 110 is not in contact with the blade 120 to thereby remain in the groove as it is, and ink in portions other than the groove are removed by the blade 120.

In addition, the pre-wipe 130 scrapes and removes the ink applied to the surface of the printing cylinder 110, while being spaced apart from the surface of the printing cylinder 110. The pre-wipe 130 is spaced apart from the surface of the printing cylinder 110 by an interval (d) corresponding to a height lower than that of the ink applied to the surface of the printing cylinder 110. Therefore, the pre-wipe 130 removes only a portion of the ink instead of all the ink.

Meanwhile, referring to FIG. 2, the printing cylinder 110 rotates in a counterclockwise direction, such that the ink applied to the surface of the printing cylinder 110 passes by the pre-wipe 130 and then reaches the blade 120. Therefore, a predetermined portion of the ink is first removed by the pre-wipe 130 and the remaining ink is removed by the blade 120.

The doctor blade apparatus 100 according to the present invention first removes a predetermined portion of the ink using the pre-wipe 130 and removes the remaining ink using the blade 120 as described above, such that an amount of ink to be removed by the blade 120 is reduced.

Therefore, ink oil pressure in the blade 120 is lowered so that the ink may be removed even though contact pressure between the printing cylinder 110 and the blade 120 is lowered.

When the contact pressure between the printing cylinder 110 and the blade 120 is lowered, abrasion of the blade 120 is reduced, thereby making it possible to remarkably improve a lifespan of the blade 120. In addition, the abrasion of the printing cylinder 110 contacting the blade 120 is also reduced, thereby making it also possible to improve a lifespan of the printing cylinder 110.

Furthermore, work suspension due to the replacement of the blade 120 can be minimized, thereby making it possible to remarkably improve productivity of the printing work.

In addition, the pre-wipe 130 is not in contact with the printing cylinder 110, thereby making it possible to have a semi-permanent lifespan.

Meanwhile, the doctor blade apparatus 100 according to the present invention may further include a spacing device 140 allowing the pre-wipe 130 to be spaced apart from the surface of the printing cylinder 110 by a predetermined interval.

The surface of the printing cylinder 110 may not maintain a predetermined position at the time of rotation of the printing cylinder 110 due to the runout of the printing cylinder, the warpage or machining error of the shaft 111, the gap of a shaft bearing 112, or the like, such that the pre-wipe 130 may be in contact with the surface of the printing cylinder 110. Therefore, the spacing device 140 is required, the spacing device 140 allowing the pre-wipe 130 to have a predetermined interval from the surface of the printing cylinder 110.

The spacing device 140 may include a bearing 113, a clamp 115, and a link 145.

The bearing 113 is fixed to a side of the printing cylinder 110 and the clamp 115 is disposed to enclose the outer peripheral surface of the bearing 113. The link 145 is connected to the clamp 115 to thereby move together with the clamp 115 according to the motion of the clamp 115.

That is, the motion of the printing cylinder 110 generated at the time of rotation thereof is transferred to the clamp 115 through the bearing 113 and is transferred again to the link 145 from the clamp 115. The pre-wipe 130 is installed at the link 145, such that the pre-wipe 130 moves together with the motion generated from the printing cylinder 110. Therefore, the pre-wipe 130 may have a predetermined interval from the surface of the printing cylinder 110.

The present invention may further include an elastic member 147 applying elasticity to the link 145 in a longitudinal direction. The link 145 is closely attached by the elastic member 147 in one direction, thereby making it possible to remove a gap that may be generated from the bearing 113 or the clamp 115.

Herein, as the elastic member 147, a spring may be used and components made of other various elastic materials may be used.

The present invention may further include a pre-wipe holder 135 controlling a position of the pre-wipe 130. The pre-wipe holder 135 is rotatably coupled to the link 145, thereby making it possible to control the spaced interval d between the pre-wipe 130 and the surface of the printing cylinder 110.

The spaced interval d of the pre-wipe 130 is controlled, thereby making it possible to control the amount of ink previously removed from the pre-wipe 130 and thus, to appropriately change the oil pressure of the ink previously transferred to the blade 120 and contact pressure between the blade 120 and the printing cylinder 110.

Hereinafter, a printing method using a doctor blade apparatus according to the present invention will be described.

The printing method using a doctor blade apparatus according to the present invention first includes removing a portion of ink applied to a surface of a printing cylinder 110 using a pre-wipe 130 installed while being spaced apart from the surface of the printing cylinder 110.

Then, the printing method includes removing ink applied to the surface of the printing cylinder using a blade 120 installed while being in contact with the surface of the printing cylinder 110. The printing cylinder 110 has a groove formed therein and having a shape intended to be printed. When the blade 120 scrapes the surface of the printing cylinder 110 to thereby remove the ink thereon, the ink remains only in the groove.

The printing method includes transferring the ink filled in the groove of the printing cylinder 110 to an object to be printed. The groove is formed in the printing cylinder 110 in a desired printing pattern and then the ink filled in the groove is transferred to the object to be printed, thereby making it possible to perform printing in a desired shape.

Meanwhile, the present invention may further include, before the removal of the portion of the ink using the pre-wipe 130, applying ink to the surface of the printing cylinder 110 by rotating the printing cylinder 110 in a condition that a portion of the printing cylinder 110 is immersed in an ink tank having ink stored therein.

That is, the ink is applied to the surface of the printing cylinder 110 while the printing cylinder is rotated in a state in which it is immersed in the ink tank, and a portion of the applied ink is primarily removed from the pre-wipe 130 and then the ink in the portions except the groove is completely removed by the blade 120.

In this case, since a portion of the ink is removed in the pre-wipe 130, the amount of ink to be removed by the blade 120 is reduced and the pressure of the ink applied to the blade 120 is also reduced. Therefore, even though the contact pressure between the printing cylinder 110 and the blade 120 is lowered as compared with that in a general case, the ink may be removed and thus abrasion of the blade 120 and the printing cylinder 100 may also be reduced. In addition, since the pre-wipe 130 is spaced apart from the printing cylinder 100, the abrasion of the pre-wipe 130 is not generated, thereby having a semi-permanent lifespan.

With the doctor blade and the printing method using the same according to the present invention, abrasion of the blade and the printing cylinder is reduced, thereby making it possible to remarkably improve a lifespan of the blade and the printing cylinder.

In addition, work suspension due to replacing the blade can be minimized, thereby making it possible to remarkably improve productivity of a printing apparatus.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims.

Accordingly, the scope of the present invention is not construed as being limited to the described embodiments but is defined by the appended claims as well as equivalents thereto.

What is claimed is:

1. A doctor blade apparatus, comprising:
a printing cylinder;
a pre-wipe removing a portion of ink applied to a surface of the printing cylinder, while being spaced apart from the surface of the printing cylinder; and
a blade removing the ink applied to the surface of the printing cylinder, while being in contact with the surface of the printing cylinder.

2. The doctor blade apparatus according to claim 1, further comprising a spacing device allowing the pre-wipe to be spaced apart from the surface of the printing cylinder by a predetermined interval.

3. The doctor blade apparatus according to claim 2, wherein the spacing device includes:
a bearing fixed to a side of the printing cylinder;
a clamp enclosing an outer peripheral surface of the bearing; and
a link having one end connected to the clamp and having the pre-wipe installed thereon.

4. The doctor blade apparatus according to claim 3, further comprising an elastic member applying elasticity to the link in a longitudinal direction.

5. The doctor blade apparatus according to claim 4, further comprising a pre-wipe holder controlling the position of the pre-wipe.

6. A printing method using a doctor blade apparatus, the method comprising:
removing a portion of ink applied to a surface of a printing cylinder using a pre-wipe installed to be spaced apart from a surface of the printing cylinder;
removing the ink applied to the surface of the printing cylinder using a blade installed to be in contact with the surface of the printing cylinder; and
transferring ink filled in a groove of the printing cylinder to an object to be printed.

7. The method according to claim 6, further comprising, before the removing of the ink using the pre-wipe, applying ink to a surface of the printing cylinder by rotating the printing cylinder in a state in which a portion of the printing cylinder is immersed in an ink tank.
